(19) United States
(12) Patent Application Publication
(10) Pub. No.: US 2007/0267994 A1
(43) Pub. Date: Nov. 22, 2007

(54) Legged Robot, Method for Controlling Legged Robot, and Device and Method for Generating Gait Data

(76) Inventor: Hisayoshi Sugihara, Aichi-Ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/661,751

(22) PCT Filed: Sep. 5, 2005
(86) PCT No.: PCT/JP05/16679

§ 371 Date: Mar. 2, 2007

(30) Foreign Application Priority Data
Sep. 3, 2004 (JP) 2004-257671

(51) Int. Cl. B25J 11/00

(52) U.S. Cl. 318/568.12; 901/1

(57) ABSTRACT

A technique is presented for allowing a legged robot to walk with leg links (in particular legs contacting the ground) extended naturally. The legged robot comprises a torso and a plurality of leg links. A base end of each leg link is swingably connected to the torso and a tip end thereof is provided with a sole. The robot comprises a gait data modifying means that modifies prepared gait data on the basis of an actual walking state, an identifying means that identifies a position of the base end for each of the leg links on the basis of a target position of the torso described in the modified gait data, a displacement amount calculating means that calculates, for each leg link, a vertical displacement amount such that, when the identified position of the base end is vertically displaced by the vertical displacement amount, a distance between the displaced position of the base end and a target position of the sole described in the modified gait data becomes equal to a predetermined distance, a selecting means that selects a maximum vertically downward displacement amount from the vertical displacement amounts calculated for the leg links, and a target position modifying means that modifies the target position of the torso described in the modified gait data in the vertical direction by the vertical displacement amount selected by the selecting means.

### CROSS-REFERENCE TO RELATED APPLICATION

The present application claims priority to Japanese Patent Application No. 2004-257671, filed on Sep. 3, 2004, the contents of which are hereby incorporated by reference into the present application.

### BACKGROUND OF THE INVENTION

1. Field of the Invention

The present invention relates to a technique for causing a machine (a legged robot) to walk, the machine having a torso to which a plurality of leg links (typically two leg links) are swingably connected.

2. Description of the Related Art

A walking legged robot (may be referred to simply as robot below) has been developed. The robot can walk by means of altering the relative posture of the torso and the leg links. The legged robot uses gait data to walk.

The gait data includes sole target position data and torso target position data. The sole target position data describes temporal changes in a target position of a sole for each leg link. The torso target position data describes temporal changes in a target position of the torso, the target position of the torso enabling the robot to continue walking in accordance with the temporal changes in the target position of the sole.

In order to generate gait data that will not cause the robot to overturn, complex calculations are required in which the dynamics of the robot taken into consideration. Below, an example thereof will be described.

(1) Sole target position data is specified that describes temporal changes in a target position of a left sole and a right sole of the robot respectively.

(2) A position is specified in which, taking the temporal changes in target position of both soles into consideration, ZMP of the robot must be present. ZMP (zero moment point) is a point on the ground where the moment caused by a resultant force acting the robot becomes zero. The resultant force includes gravitational force, ground reaction force, and inertial force. If the ZMP is within a sole of the leg link contacting the ground, the robot will not overturn. In other words, the ZMP must be within the sole of the leg link contacting the ground in order to prevent the robot from overturning. Consequently, taking into consideration the position of the sole of the leg link contacting the ground, a target ZMP is specified that fulfills the following relationships: while one leg link (e.g. the left leg) is raised, the ZMP is within the sole of the leg link contacting the ground (the right leg); when the sole of the raised leg (the left leg) lands and both sole are on the ground, the ZMP now begins to move to the sole of the leg link that has just landed (the left leg); and the ZMP completes its movement into the sole of the leg link that has just landed (the left leg) before the other leg (the right leg) is raised from the ground. The ZMP specified in this manner is termed target ZMP. If the actual ZMP moves in the same manner as the target ZMP, the robot can walk without overturning.

(3) When the temporal changes in positions of both soles and, following this, the target ZMP have been specified, the temporal changes in position of the torso are predicted, and the dynamics of the robot are calculated. Since the sole positions have been specified at the time of this calculation, the posture of the robot can be determined when the position of the torso has been predicted. When the posture of the robot has been determined, it is possible to calculate the position of the ZMP at that posture. In order to calculate the position of the ZMP, the effects of inertial force acting on the robot must also be taken into account in addition to static elements. By including the predicted temporal changes in the position of the torso in the calculations, it becomes possible to calculate the position of the ZMP taking the dynamics of the robot into consideration. Since the position of the ZMP can be calculated when the temporal changes in the position of the torso (torso trajectory) can be predicted, it is possible to seek the temporal changes in the position of the torso (torso trajectory) whereby actual ZMP conforms to the target ZMP.

(4) Gait data is prepared in advance using the above steps.

The robot is provided with a joint angle calculating device that can calculate joint angle of each joint by solving inverse kinematics from the gait data. When the robot actually operates, the joint angle of each joint is calculated in accordance with the gait data. By adjusting joint angle of each joint to the calculated joint angle, the robot can walk in accordance with the gait data. If the robot walks in accordance with the gait data, the actual ZMP conforms to the target ZMP, and the robot can walk without overturning.

Position of the torso or the sole can be described in terms of changes of position with respect to time. And, since position, velocity, and acceleration are related, it is possible to calculate the other two values from any one of the three, and consequently position can be described in terms of velocity or acceleration. The position data includes data that specifies position in terms of velocity or acceleration.

Since the soles and the torso are rigid bodies, the position of the sole or the torso can be represented by positions of representative points thereof. And, the position of the sole or the torso includes not only a position, but also attitude of the sole or torso. The attitude of the sole or the torso can be described by the attitude angle of the sole or the torso. In the case where the attitude of the sole or the torso follows a predetermined pattern during walking, the gait data need not to include data describing the attitude of the sole or the torso.

Analytically finding the temporal changes in the target position of the torso (usually including the attitude of the torso) that causes the actual ZMP conforming to the target ZMP is a typical example of methods for calculating the target position of the torso that enables the robot to move the torso in accordance with the target positions of the soles without overturn. The method for calculating the target position of the torso is not limited to the aforementioned method.

While the robot is walking according to the prepared gait data, disturbing force may be exerted on the robot unexpectedly. Such disturbing force may be applied from unexpected irregularities of the ground surface or may be external pushing or pulling force applied from outside the robot. And, as in the case of disturbing force being exerted on the robot, the actual position or posture of the robot may deviate from the gait data due to the structural bending of the robot, rattling of the joints, delayed response of the robot. If disturbing force is exerted on the robot unexpectedly, the robot can not continue walking in accordance to the prepared gait data.

To deal with this, the robot is provided with a means to modify the prepared gait data on the basis of the actual walking state. For example, when disturbing force is exerted on the robot unexpectedly, the robot modifies the target position of the torso in the prepared gait in order to continue walking.

### BRIEF SUMMARY OF THE INVENTION

If the leg links (particularly the leg links contacting the ground) have already fully extended when the prepared gait data is modified on the basis of the actual walking state, the robot can not move the torso or the soles to the modified target position. In this case, there is a possibility of the robot overturning.

To deal with this, in a conventional technique, the height of the torso is set to be lower in the prepared gait data. When this gait data is used, the leg links do not become fully extended. When modifications are made on the basis of the actual walking state, the leg links can be extended further if necessary. In order to be able to make modifications based on the actual walking state, the gait data that can prevent leg links from fully extending is prepared in advance.

However, as a consequence of that, the leg link contacting the ground is bent constantly while the robot walks according to the prepared gait data. In order to be able to make modifications based on the actual walking state, the leg link contacting the ground must remain in a constantly bent state and be ready to extend as the need arises. Therefore, in usual circumstance, the robot must walk with the leg link contacting the ground in a constantly bent state.

However, when the robot walks with the leg link contacting the ground in a constantly bent state, a larger bending moment is applied to the joint of the leg link. This is equivalent to the fact that, when a person walks with bent knees, stronger tension is applied on the thigh muscles and a heavier load is exerted on the knee joints as compared to when the person walks with extended knees. Further, in the case of a bipedal robot that imitates human beings, the walking of the robot appears particularly unnatural if the leg link contacting the ground is in a constantly bent state.

The present invention solves the above problem. The present invention presents a technique allowing a robot to walk with the leg links (particularly the leg link or leg links contacting the ground) extended.

A legged robot embodied by the present invention is provided with a torso and a plurality of leg links. A base end of each leg link is swingably connected to the torso, and a tip end of each leg link is provided with a sole. The robot is provided with a gait data modifying means that modifies prepared gait data on the basis of an actual walking state.

The robot can further modify the modified gait data. For this purpose, the robot is provided with an identifying means, a displacement amount calculating means. The identifying means identifies a position of the base end for each of the leg links on the basis of a target position of the torso described in the modified gait data. The displacement amount calculating means calculates a vertical displacement amount such that, when the identified position of the base end is vertically displaced by the vertical displacement amount, a distance between the displaced position of the base end and a target position of the sole described in the modified gait data becomes equal to a predetermined distance. These means are provided for each of the leg links. And, the robot is further provided with a selecting means, and a target position modifying means. The selecting means selects a maximum vertically downward displacement amount from the vertical displacement amounts calculated for the leg links. The target position modifying means modifies the target position of the torso described in the modified gait data in the vertical directions by the vertical displacement amount selected by the selecting means.

As described above, the robot can walk by using the prepared gait data. Since it can not be avoided that the disturbing force is applied to the robot unexpectedly, the robot is provided with the means that modifies the prepared gait data on the basis of the actual walking state. At this juncture, if the leg links (particularly the leg link or leg links contacting the ground) are already in an extended state due to the prepared gait data, it may not be possible to move the torso or the soles to the target position modified on the basis of the actual walking state. To deal with this, the conventional technique required that the prepared gait data must describe walking postures in which the leg links are not fully extended.

In the present invention, the target position modifying means is utilized, and it is thus possible to modify, in the vertical directions, the target position of the torso described in the modified gait. Consequently, it is no longer necessary to prepare gait data in advance that order the robot to walk with the leg links not fully extended. With the present invention, in the case where the leg links (particularly the leg link or leg links contacting the ground) are already fully extended in accordance with the prepared gait data, if the target position of the torso or the soles is modified to a position that requires the leg link to be extended further, the target position can be modified vertically downward by an amount that compensates for the insufficient length of the leg link. By contrast, it could not be possible to deal with the situation with the conventional technique since the leg links could not be extended further.

For the above purpose, in the present invention, the means is utilized that identifies a position of the base end for each of the leg links on the basis of the target position of the torso described in the modified gait data. Further, the means is utilized that calculates a distance between the identified position of the base end and a target position of the sole described in the modified gait data. The calculating means can also calculate the distance between the base end and the sole in case the identified position of the base end is displaced in the vertical directions. The calculating means can further calculate a vertical displacement amount such that, when the identified position of the base end is vertically displaced by the vertical displacement amount, the distance between the base end and the sole becomes equal to a predetermined distance. The calculating means calculates the vertical displacement amount for each of the leg links. At this juncture, since the position of the sole represents a position of the tip end of the leg link, the target position of the sole can be used for the calculation directly, or the position of the tip end of the leg link can be used for the calculation by means of identifying the position of the tip end on the basis of the target position of the sole. If the predetermined distance is set with a distance that can be realized by the leg link with a limited length, the robot can walk in accordance with the modified gait data. It is no longer necessary to describe walking postures in which the leg link is not fully extended in the prepared gait data.

In this robot, the maximum vertically downward displacement amount of is selected from the vertical displacement amounts calculated for the leg links, and the target position of the torso described in the modified gait data is modified in the vertical directions by the vertical displacement amount that was selected. The gait data can thus be modified to be realizable for all of the leg links. Although there may be leg links of which the base end is modified vertically downwards by a larger displacement amount with respect to the length of the leg links, this can be dealt with by bending the leg links.

When the target position of the torso is modified in the vertical directions, an actual ZMP will deviate from the target ZMP. However, only when the target position of the torso is displaced in the vertical direction, the deviation from the target ZMP is small and does not causes other problems. With this legged robot, it is not necessary to prepare gait data with which the robot walks with the leg links (particularly the leg link or leg links contacting the ground) in a constantly bent state. The legged robot can walk with the leg links extended naturally.

In the aforementioned legged robot, it is preferred that the prepared gait data is utilized that describes walking postures in which the leg links are extended naturally. And, it is preferred that a distance calculating means is provided that calculates a distance between a position of the base end identified on the basis of the target position of the torso described in the prepared gait data and a target position of the sole described in the prepared gait data. This distance calculating means can calculate the distance between the base end and the sole for each of the leg links. Further, it is preferred that the displacement amount calculating means uses the distance calculated by the distance calculating means as the predetermined distance to calculate the vertical displacement amount. In this robot, the distance between the base end and the sole of the leg links prescribed in the modified gait data is close to the distance between the base end and the sole prescribed in the prepared gait data. The robot can thus walk while maintaining the walking posture that has been intended by the operator or the like who has created the prepared gait data.

In the aforementioned legged robot, It is preferred that the selecting means selects zero if there is no vertically downward displacement amount in the vertical displacement amounts calculated for the leg links. If the position of the torso is displaced vertically upward, gait of the robot may become unnatural. In this robot, when the target position of the torso is modified in the modified gait data, it is permitted the target position of the torso is displaced only vertical downward, and not permitted that the target position of the torso is displaced vertical upward. The legged robot can thus walk with the leg links extended in a more natural manner. In this case, it is further preferred that a vertical coordinate of the torso target position is set at a level where the robot walks with the leg links fully extended in the prepared gait data. In this way, it can be possible that vertically downward modification occurs frequently and vertical upward modification occurs infrequently.

The technique of the present invention can also be realized by a method for controlling a walking operation of a legged robot. This walk controlling method can control the robot provided with a plurality of leg links wherein each leg link comprises a base end swingably connected to the torso and a tip end provided with a sole. The walk controlling method comprises a step of preparing gait data that describes anticipated walking for the robot, and a step of modifying the prepared gait data on the basis of an actual walking state.

In this walk controlling method, the gait data is further modified. Provided for this purpose are a step of identifying a position of the base of the leg link on the basis of a target position of the torso described in the modified gait data and a step of calculating a vertical displacement amount such that, when the identified position of the base end is vertically displaced by the vertical displacement amount, a distance between the displaced position of the base end and the target position of the sole becomes equal to a predetermined distance. In these steps, the calculations are performed for each of the leg links. Further provided are a step of selecting a maximum vertically downward displacement amount from the vertical displacement amounts calculated for each of the leg links, a step of modifying the target position of the torso described in the modified gait data in the vertical directions by the vertical displacement amount that is selected, and a step of inputting the modified gait data to a joint angle calculating device of the legged robot after modification of the target position of the torso. With this walk controlling method, there is no longer any need to prepare gait data with which the robot walks while the leg links (in particular, the leg link or leg links contacting the ground) are unnecessarily bent. The legged robot can walk with the leg links extended naturally.

The present invention further presents a device for preparing in advance gait data used by a legged robot. This gait data generating device is utilized for preparing gait data that is input to a robot provided with a plurality of leg links wherein a base end of each leg link is swingably connected to the torso and a tip end thereof is provided with a sole. The gait data generating device comprises a storing means for storing sole target position data that describes temporal changes in a target position of the sole for each of the leg links, and a predicting means that predicts temporal changes in a target position of the sole that enables the robot to walk in accordance with the sole target position data.

In order to modify the predicted target position of the torso, the gait data generating device is further provided with an identifying means and a displacement amount calculating means. The identifying means identifies a position of the base end of the leg link on the basis of a predicted target position of the torso. The displacement amount calculating means calculates a vertical displacement amount such that, when the identified position of the base end is vertically displaced by the vertical displacement amount, the distance between the displaced position of the base end and the target position of the torso stored in the sole target position data becomes equal to a predetermined distance. These means are provided for each of the leg links. Further, the gait data generating device provided with a selecting means that selects a maximum vertically downward displacement amount from the vertical displacement amounts calculated for each of the leg links, and a modifying means that modifies the predicted target position of the torso by the vertical displacement amount selected by the selecting means. Moreover, the gait data generating device is provided with a repredicting means that repredicts temporal changes in the target position of the torso if the modified target position of the torso is not a position that enables the robot to walk in accordance with the stored sole target position data.

In this device, temporal changes in the target position of the torso are predicted that allow the legged robot to walk, without overturning, in accordance with the sole target position data which describes temporal changes in the target position of the sole for each of the leg links. In the step of predicting the temporal changes in the target position of the torso, it is not necessary to take the length of each leg link into consideration. The target position of the torso can be predicted to be too high to be realized for the length of each leg link.

In this device, the position of the base end of the leg link is initially identified on the basis of the predicted target position of the torso. And, the vertical displacement amount is calculated such that, when the identified position of the base end is vertically displaced by the vertical displacement amount, the distance between the displaced position of the base end and the stored target position of the sole becomes equal to a predetermined distance. The vertical displacement amount is calculated for each of the leg links.

In this device, the maximum vertically downward displacement amount is selected from the vertical displacement amounts calculated for each of the leg links, and the predicted target position of the torso is modified by the selected vertical displacement amount in the vertical directions. It is thus possible to modify the target position of the torso to be realizable with respect to the length of each of the leg links.

In this device, the temporal changes in the target position of the torso are repredicted if the modified target position of the torso is not a position that enables the robot to walk in accordance with the stored sole target position data. The newly predicted target position of the torso can be remodified in the vertical directions by means of the aforementioned processes. In this device, the temporal changes in the position of the torso are predicted, the vertical coordinate of the predicted target position of the torso is modified, and a target position of the torso is sought that allows the legged robot to walk. The resulting target position of the torso is a position that is realizable with respect to the length of each of the leg links. In this gait data generating device, when the predicted target position of the torso need to be modified, the predicted target position of the torso is modified in the vertical directions. It is thus possible to cause a large change in the distance between the base end and the sole of each leg link without causing a large change in the dynamic balance of the legged robot.

With this gait data generating device, it is possible to generate gait data that enables the legged robot to walk with its leg links extended naturally. The gait data generated by this gait data generating device can be used effectively in the aforementioned legged robot and the aforementioned walk controlling method of the legged robot. The aforementioned legged robot or the walk controlling method of the legged robot can efficiently utilize gait data that order the robot to walk with the leg links extended naturally, and do not require gait data in which the leg links are bent.

The technical concept of the present invention can be used in a process of preparing the gait data in advance, and can be used in a process of controlling actual walking of the robot while modifying the gait data.

With respects to the aforementioned vertical displacement amount calculating means, it is preferred that a fully extended length of the leg link is used as the vertical displacement amount in order to calculate the vertical displacement amount. It is thus possible to generate gait data that enables the robot to walk with at least one of the leg links fully extended.

The target position of the torso, obtained by making modification in the vertical directions, changes over time, and thus defines a trajectory. Then, It is preferred that this trajectory does not change discontinuously, but is a smooth continuous curved line. For this purpose, it is preferred that the device for generating gait data is further provided with a sampling means that samples, at predetermined periods, the target position of the torso that have been vertically modified, a smoothed trajectory generating means that generates a smoothed trajectory that follows the sampled torso target positions with a continuous curved line, a detecting means that detects a period in which the generated smoothed trajectory is positioned vertically upward from the modified target position of the torso, a remodifying means that remodifies, by a predetermined vertically downward amount, the modified target position of the torso corresponding to the detected period, and a smoothed trajectory regenerating means that regenerates a smoothed trajectory using the remodified target position of the torso.

This gait data generating device can sample, at predetermined periods, the target position of the torso (that changes its height and horizontal position over time) that have been modified vertically downward. And, this device can generate a smoothed trajectory that follows a plurality of sampled target positions of the torso with a continuous curved line. In the smoothed trajectory generated with this manner, there may be periods in which the smoothed trajectory is positioned vertically upwards from the target position of the torso prior to smoothing. Since the smoothed trajectory in these periods is too high for at least one of the leg links, the smoothed trajectory should be modified before utilizing. To deal with this, the gait data generating device can detect periods in which the generated trajectory is positioned vertically upwards from the target position of the torso prior to smoothing. And, in these detected periods, the gait data generating device can further modify the target position of the torso vertically downward by a predetermined amount. Then, the gait data generating device can regenerate a smoothed trajectory. By repeating the above processes, the gait data generating device can obtain a smoothed trajectory that is always positioned vertically downwards from the target position of the torso that was initially calculated, and that is realizable with respect to the length of the leg links.

The technique of the present invention can also be embodied in a method of generating gait data. This gait data generating method is utilized for preparing gait data that is input to a robot provided with a plurality of leg links wherein a base end of each leg link is swingably connected with a torso and a tip end thereof is provided with a sole. This gait data generating method is provided with a step of storing sole target position data describing temporal changes in a target position of the sole for each of leg links, and a step of predicting temporal changes in a target position of the torso that allows the robot to walk in accordance with the sole target position data. In order to modify the predicted target position of the torso, the method is further provided with a step of identifying a position of the base end of the leg link on the basis of the predicted target position of the torso and a step of calculating a vertical displacement amount such that, when the identified position of the base end is vertically displaced by the vertical displacement amount, a distance between the displaced position of the base end and the target position of the sole described in the stored sole target position data becomes equal to a predetermined distance. These steps are executed for each of the leg links. The method is further provided with a step of selecting a maximum vertically downward displacement amount from the vertical displacement amounts calculated for each of the leg links and a step of modifying the predicted target position of the torso in the vertical directions by the vertical displacement amount selected in the selecting step. The method is further provided with a step of repredicting temporal changes in the target position of the torso if the modified target position of the torso is not a position that enables the robot to walk in accordance with the stored sole target position data.

With this gait data generating method, it is possible to generate gait data that order the legged robot to walk with its leg links extended naturally. The gait data generated by this gait data generating method can be utilized effectively in the aforementioned legged robot and in the aforementioned walk controlling method of the legged robot.

With the present invention, it can be possible to order the legged robot to walk with the leg links (particularly the leg or legs contacting the ground) extended.

### BRIEF DESCRIPTION OF THE DRAWINGS

FIG. 1 schematically shows a robot of a first embodiment.

FIG. 2 is a block diagram showing the configuration of a control device mounted on the robot.

FIG. 3 is a block diagram showing the configuration of a torso position modifying device of the control device.

FIG. 4 shows the position of both ends of leg links when prepared gait data is being followed.

FIG. 5 shows the position of both ends of the leg links when modified gait data is being followed.

FIG. 6 is a figure describing modification amounts of the torso position.

FIG. 7 shows the position of both ends of the leg links when the torso position has been modified.

FIG. 8 is a flowchart showing the flow of processes of the control device.

FIG. 9 is a flowchart showing the flow of processes of the torso position modifying device.

FIG. 10 is a block diagram showing the configuration of a gait data generating device of a second embodiment.

FIG. 11 shows a trajectory of the torso described by data stored in a storage device.

FIG. 12 is a block diagram showing the configuration of a torso trajectory data generating device.

FIG. 13 shows the vertical trajectory of the torso described by the torso trajectory data.

FIG. 14 shows a smoothed trajectory generated from sampled trajectory points.

FIG. 15 shows a smoothed trajectory generated from remodified trajectory points.

### DETAILED DESCRIPTION OF THE INVENTION

First, the main features of the embodiments described below are listed.

(Feature 1) The robot is provided with a gait data modifying device that modifies a target position of the torso described in a prepared gait data on the basis of an actual walking state.

(Feature 2) The gait data modifying device of the robot modifies the target position of the torso described in the prepared gait data to be displaced in the horizontal directions.

(Feature 3) The gait data generating device is provided with a device that determines whether the predicted target position of the torso enables the robot to walk in accordance with provided temporal changes in the target position of the sole.

### EMBODIMENT 1

An embodiment 1 of the present invention will be described with reference to figures. In the present embodiment, the technique of the present invention is applied to a bipedal walking robot.

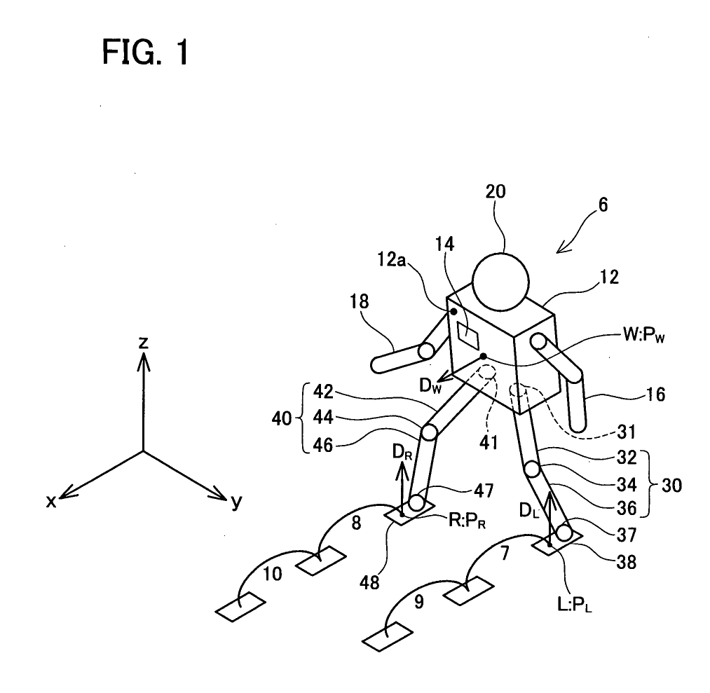

FIG. 1 shows a bipedal walking robot (hereafter simply termed robot) 6 of the present embodiment. As shown in FIG. 1, the robot 6 comprises a torso 12 and two legs, a left leg link 30 and a right leg link 40, that are swingably connected with the torso 12. Further, the robot 6 comprises a left arm link 16, a right arm link 18, and head 20 that are swingably connected with the torso 12.

As shown in FIG. 1, the left leg link 30 comprises a left thigh 32, a left lower leg 36, and a left knee joint 34 that connects the left thigh 32 and the left lower leg 36. The left knee joint 34 is a joint that has a rotational degree of freedom with respect to a single axis. A base end of the left leg link 30 is connected with the torso 12 via a left hip joint 31. A left sole 38 is connected with a tip end of the left leg link 30 via a left ankle joint 37. The left hip joint 31 is a joint that has a rotational degree of freedom with respect to three axes, and the left ankle joint 37 is a joint that has a rotational degree of freedom with respect to two axes.

The right leg link 40 is formed as a mirror image of the left leg link 30. For the right leg link 40, FIG. 1 shows a right hip joint 41, a right thigh 42, a right knee joint 44, a right lower leg 46, a right ankle joint 47, and a right sole 48.

The robot 6 is provided with actuators for driving the joints. The actuators are controlled by a control device 14 (to be described). The robot 6 is provided with sensors for detecting actual motion of the robot 6. The sensors are, for example, encoders for detecting a joint angle of the joints, acceleration sensors for detecting motion of the torso 12, etc. Output signals from the sensors are utilized in processes of the control device 14 (to be described).

As shown in FIG. 1, the robot 6 walks such that, while the right sole 48 is contacting the ground, the robot 6 raises the left leg link 30 and moves the left sole 38 along a trajectory 7. Then, while the left sole 38 is contacting the ground, the robot 6 raises the right leg link 40 raised and moves the right sole 48 along a trajectory 8. Similarly, the robot moves the left sole 38 along a trajectory 9, then moves the right sole 48 along a trajectory 10.

In the present embodiment, as shown in FIG. 1, an x-axis is a direction that the robot 6 walks, a y-axis is defined along a direction to the sides of the robot 6, and a z-axis is defined along a direction of height. The xy plane is a horizontal plane, and the direction of the axis z is the vertical directions.

The robot 6 requires gait data to perform the walking operation shown in FIG. 1. The gait data is prepared in advance by an operator, and is input to the robot 6. The prepared gait data can be generated by a gait data generating device that utilizes a computing device. In the gait data generating process, the operator provides sole target position data, and inputs this to the gait data generating device. Then, based on the sole target position data that has been input and a dynamic model of the robot 6, the gait data generating device calculates motion of the torso 12 that enables the robot 6 to walk under projected conditions, and generates torso target position data that describes the motion that has been calculated of the torso 12.

The gait data utilized by the robot 6 comprises left sole target position data that describe temporal changes in a position and an attitude targeted for the left sole 38, right sole target position data that describe temporal changes in a position and an attitude targeted for the right sole 48, torso target position data that describe temporal changes in a position and an attitude targeted for the torso 12, hand target position data that describe temporal changes in a position and an attitude targeted for left and right hands, target ZMP data that describe temporal changes in target ZMP, etc.

The torso target position data is described a position P_{W} (x_{W}, y_{W}, z_{W}) of a representative point W of the torso 12 and attitude angles (a roll angle, a pitch angle, and a yaw angle) of the attitude of the torso 12. The left sole target position data is described a position P_{L} (x_{L}, y_{L}, z_{L}) of a representative point L of the left sole 38 and attitude angles of the attitude of the left sole 38. The right sole target position data is described a position P_{R} (x_{R}, y_{R}, z_{R}) of a representative point R of the right sole 48 and attitude angles of the attitude of the right sole 48. These data of the position and attitude are temporal data wherein the values change over time.

The robot 6 is provided with the control device 14 that controls the operation of the robot 6. The control device 14 comprises a CPU, ROM, RAM, hard disk, etc. Hardware configuration of the control device 14 is the same as a conventional computer, and a explanation thereof is omitted.

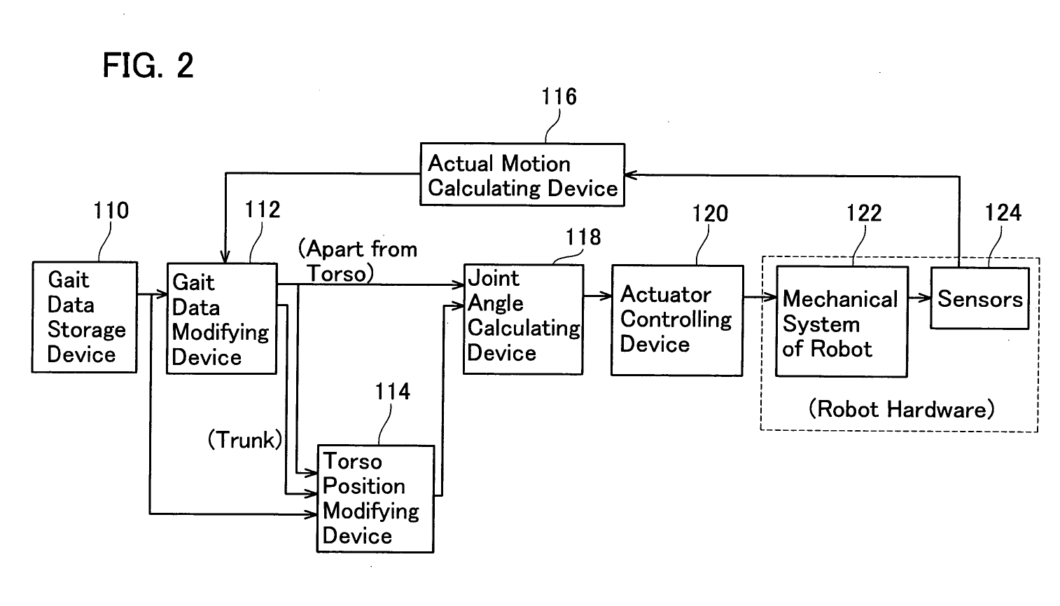

FIG. 2 is a block diagram showing the functional configuration of the control device 14. As shown in FIG. 2, the control device 14 functionally comprises a gait data storage device 110, a gait data modifying device 112, a torso position modifying device 114, a joint angle calculating device 118, an actuator controlling device 120, an actual motion calculating device 116, etc. In the elements shown in FIG. 2, a mechanical system 122 of the robot, and sensors 124 are not included in the configurational elements of the control device 14. However, these are included for the sake of clarifying the following description.

The control device 14 may be included in its entirety in a single physical device, or may be divided and housed in separate physical devices. Further, the elements of the control device 14 need not necessarily be mounted on the robot 6. The elements of the control device 14 may be disposed to the exterior of the robot 6, and may be input to the robot 6 wirelessly or via wires.

The gait data storage device 110 stores gait data prepared in advance by an operator or the like. The gait data stored in the gait data storage device 110 is input to the gait data modifying device 112 and the torso position modifying device 114. The gait data modifying device 112 modifies the gait data input from the gait data storage device 110 based on the actual motion of the robot 6 input from the actual motion calculating device 116. The modified gait data is input to the torso position modifying device 114 and the joint angle calculating device 118. Here, the modified torso target position data is not input to the joint angle calculating device 118, but is input only to the torso position modifying device 114. The torso position modifying device 114 modifies, with the length of the left leg link 30 and the right leg link 40 taken into consideration, the z coordinate of the target position of the torso 12 that was modified by the gait data modifying device 112. Details of the torso position modifying device 114 will be described later.

The torso target position data, and the target position data of the left sole 38 and the right sole 48 is input to the joint angle calculating device 118. The joint angle calculating device 118 can calculate the joint angles θ1 (t), θ2 (t), θ3 (t), . . . of the robot 6 by solving inverse kinematics on the basis of the target positions that have been input. The calculated joint angle data is input to the actuator controlling device 120. The actuator controlling device 120 can control the actuators mounted on the robot 6 on the basis of the joint angle data that has been input. By controlling the actuators, the actuator controlling device 120 implements the walking operation of the mechanical system 122 of the robot 6.

The actual walking operation of the robot 6 is affected by disturbing forces such as unanticipated irregularities of a ground surface, structural bending of the robot, etc. The actual walking operation of the robot 6 is detected by the sensors 124 mounted on the robot 6. The actual motion calculating device 116 calculates the actual motion of the robot 6 on the basis of the signals output from the sensors 124. The actual motion calculating device 116 can calculate, for example, the actual motion of the left sole 38, the actual motion of the right sole 48, and the actual motion of the torso 12. The actual motion of the robot 6 that has been calculated by the actual motion calculating device 116 is input to the gait data modifying device 112.

As described above, the gait data modifying device 112 modifies the gait data stored in the gait data storage device 110 on the basis of the actual motion of the robot 6 calculated by the actual motion calculating device 116. The control device 14 controls the walking operation of the robot 6 while giving feedback based on the actual walking motion of the robot 6.

The process of the gait data modifying device 112, whereby the gait data is modified on the basis of the actual motion of the robot 6, will now be described. First, the gait data modifying device 112 modifies the target position and attitude of the left sole 38 and the target position and attitude of the right sole 48 on the basis of the actual motion of the robot 6. Next, the gait data modifying device 112 modifies the target position of the torso on the basis of the modified target positions and attitudes of the left sole 38 and the right sole 48. In case the gait data modifying device 112 modifies the target position of the torso 12, the gait data modifying device 112 modifies the target position of the torso 12 so as to be displaced within a horizontal plane. That is, the z coordinate of the torso target position is fixed.

In walking robots like the robot 6, if the position of the torso 12 is modified in a horizontal direction, the position of the ZMP moves a great deal. By contrast, if the position of the torso 12 is modified in a vertical direction, the position of the ZMP hardly moves. As a result, the torso target position can be modified such that the ZMP conforms to the target ZMP even if the torso target position is modified only in the horizontal direction.

Further, the method for modifying the gait data on the basis of the actual walking state of the robot 6 is not restricted to the above method. For example, a camera can be mounted on the robot 6, and the gait data can be modified while irregularities of the walking surface ahead are being detected. The robot 6 can have various types of methods for modifying the input gait data in response to actual conditions.

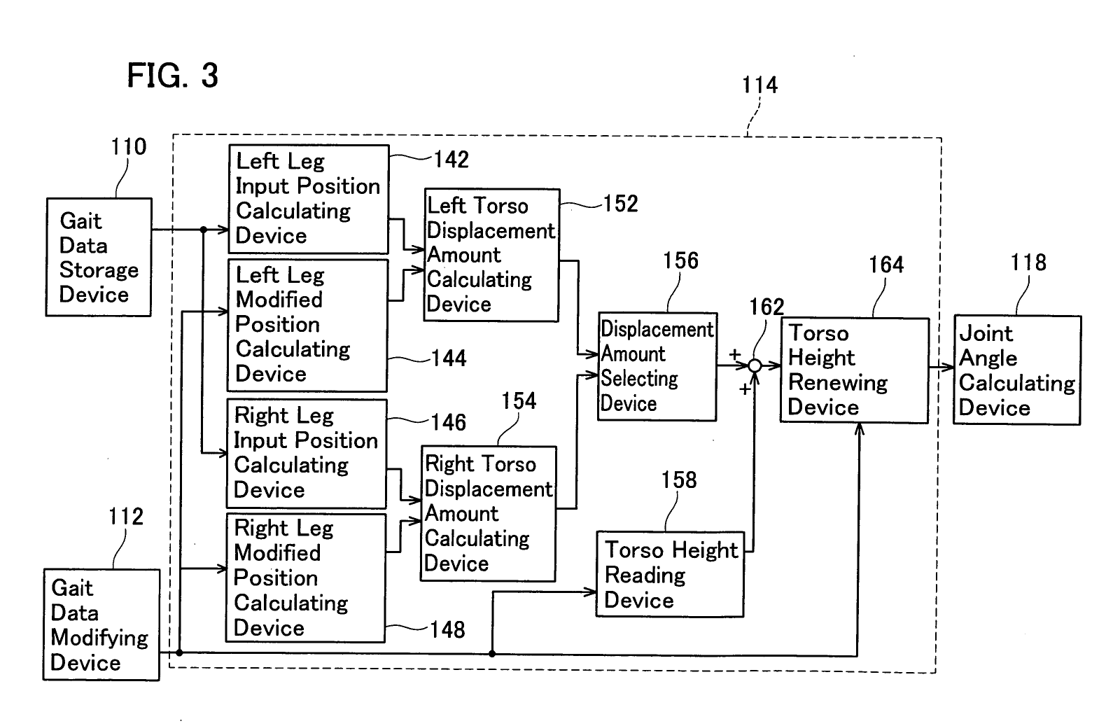

FIG. 3 is a block diagram showing the functional configuration of the torso position modifying device 114. As shown in FIG. 3, the torso position modifying device 114 functionally comprises a left leg input position calculating device 142, a left leg modified position calculating device 144, a right leg input position calculating device 146, a right leg modified position calculating device 148, a left torso displacement amount calculating device 152, a right torso displacement amount calculating device 154, a displacement amount selecting device 156, a torso height reading device 158, an adder 162, and a torso height renewing device 164.

The prepared gait data stored in the gait data storage device 110 is input to the left leg input position calculating device 142. The left leg input position calculating device 142 calculates the relative position of the left hip joint 31 with respect to the left ankle joint 37 represented in the gait data that has been input.

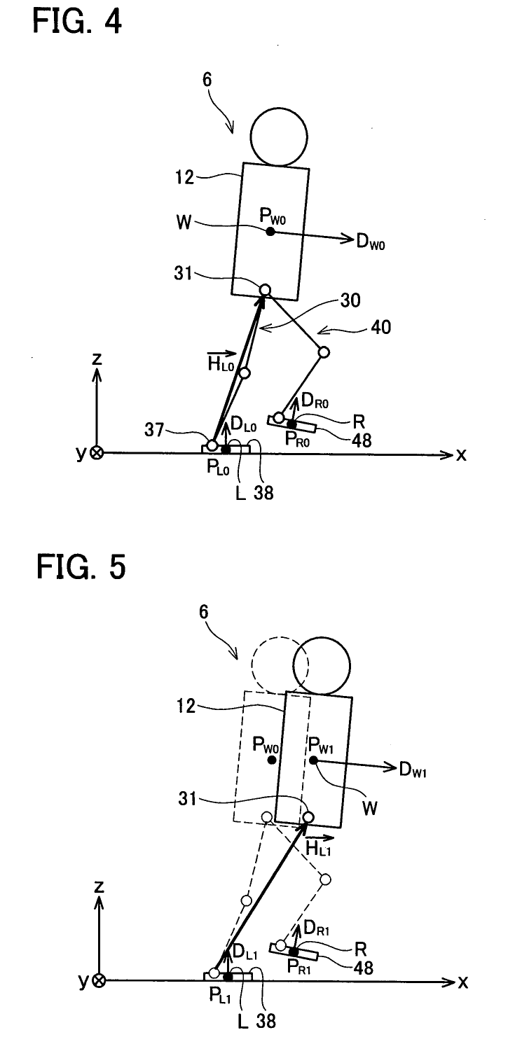

The process of the left leg input position calculating device 142 will be described with reference to FIG. 4. FIG. 4 schematically shows the robot 6 while following the gait data stored in the gait data storage device 110. In FIG. 4, a point P_{W0} shows the target position of the torso 12 and an arrow D_{W0} shows the target attitude of the torso 12 described in the gait data stored in the gait data storage device 110. The target attitude D_{W0} of the torso 12 can, for example, be described with a matrix of the roll angle, pitch angle, and yaw angle. Similarly, a point PLO shows the target position of the left sole 38, an arrow D_{L0} shows the target attitude of the left sole 38, a point P_{R0} shows the target position of the right sole 48, and an arrow D_{R0} shows the target attitude of the right sole 48.

The left leg input position calculating device 142 calculates the position of the left hip joint 31 on the basis of the target position P_{W0} of the torso 12, the target attitude D_{W0} of the torso 12, and the positional relationship between the left hip joint 31 and the representative point W of the torso 12 that has been taught in advance. The position of the left hip joint 31 is also the position of the base end at the torso 12 side of the left leg link 30. Furthermore, the left leg input position calculating device 142 calculates the position of the left ankle joint 37 on the basis of the target position P_{L0} of the left sole 38, the target attitude D_{L0} of the left sole 38, and the positional relationship between the left ankle joint 37 and the representative point L of the left sole 38 that has been taught in advance. The position of the left ankle joint 37 is also the position of the tip end at the left sole 38 side of the leg link 30. Then, the left leg input position calculating device 142 calculate a vector H_{L0}=(x_{L0}, y_{L0}, z_{L0}) that points from the position of the left ankle joint 37 to the position of the left hip joint 31.

The gait data that has been modified by the gait data modifying device 112 is input to the left leg modified position calculating device 144. The left leg modified position calculating device 144 calculates the positional relationship of the left hip joint 31 with respect to the left ankle joint 37 represented in the modified gait data that has been input.

The process of the left leg modified position calculating device 144 will be described with reference to FIG. 5. FIG. 5 schematically shows the robot 6 following the gait data that has been modified by the gait data modifying device 112. The target position of the torso 12 represented in the modified gait data is P_{W1}. The target attitude of the torso 12 is D_{W1}. The target position of the left sole 38 is P_{L1}. The target attitude of the left sole 38 is D_{L1}. The target position of the right sole 48 is P_{R1}. The target attitude of the right sole 48 is D_{R1}. Since the gait data modifying device 112 displaces the target position of the torso 12 in the horizontal direction when modifying the gait data, the modified target position P_{W1} of the torso 12 is a position that has been displaced in the horizontal direction from the target position P_{W0} of the torso 12 prior to modification.

The left leg input position calculating device 142 calculates the position of the left hip joint 31 on the basis of the target position P_{W1} of the torso 12, the target attitude D_{W1} of the torso 12, and the positional relationship between the left hip joint 31 and the representative point W of the torso 12 that has been taught in advance. Furthermore, the left leg input position calculating device 142 calculates the position of the left ankle joint 37 on the basis of the target position P_{L0} of the left sole 38, the target attitude D_{L0} of the left sole 38, and the positional relationship between the left ankle joint 37 and the representative point L of the left sole 38 that has been taught in advance. Then, the left leg input position calculating device 142 calculates a vector H_{L1}=(x_{L1}, y_{L1}, z_{L1}) that points from the position of the left ankle joint 37 to the position of the left hip joint 31. Here, Z_{L1}=Z_{L0}.

The distance between the left ankle joint 37 and the left hip joint 31 represented in the gait data differs before and after the gait data is modified. That is, the length of the vector H_{L0} shown in FIG. 4 is not the same as the length of the vector H_{L1} shown in FIG. 5. The distance between the left ankle joint 37 and the left hip joint 31 represented in the gait data after modification (the length of the vector H_{L1}) may exceed the fully extended length of the left leg link 30 (hereafter, simply termed length of the left leg link 30). Here, the fully extended length (or the length) of the left leg link 30 means a distance between both its ends when the left leg link 30 is fully extended. In this case, the gait data after modification is gait data that cannot be realized with respect to the length of the left leg link 30. In order to avoid such results, it was necessary with the conventional technique to set an upper limit of the distance between the left ankle joint 37 and the left hip joint 31 to be sufficiently lower than the length of the left leg link 30 in the prepared gait data. As a result, the robot walked with the knee joint of the leg contacting the ground bent unnaturally.

In the gait data modifying step, the robot 6 of the present embodiment allows the gait data to be modified to become gait data that cannot actually be realized with the fully extended length of the left leg link 30. In other words, the upper limit of the distance between the left ankle joint 37 and the left hip joint 31 can be set so as to be approximately equal to the length of the left leg link 30 in the prepared gait data.

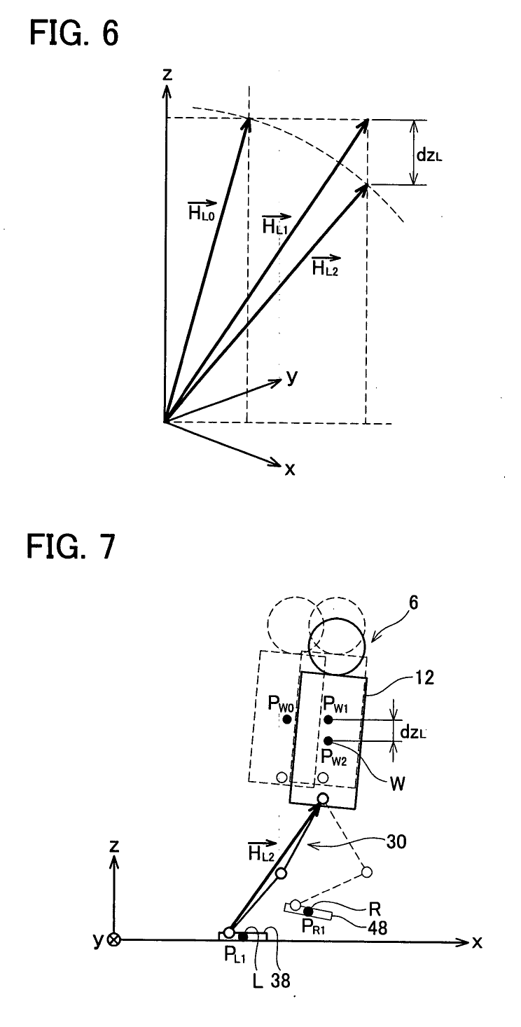

As shown in FIG. 6, the left torso displacement amount calculating device 152 can calculate a displacement amount dz_{L} such that, when the z directional element z_{L1} of the vector H_{L1} is modified by the displacement amount dz_{L}, the vector after modification (the vector H_{L2} in the figure) becomes the same length as the length |H_{L0}| of the vector H_{L0}. The displacement amount dz_{L} can be calculated as:
dz_{L}=−z_{L1}+(|H_{L0}|²−(x_{L1})²−(y_{L1})²)^{1/2}
Here,
|H_{L0}|²=(x_{L0})²+(y_{L0})²+(z_{L0})²
dz_{L} is a value that can be either positive or negative. When dz_{L} is a positive value, this shows modification in a positive direction of the z axis (vertically upwards).

FIG. 7 shows a position P_{W2} which is the displaced position when the target position P_{W1} of the torso 12 represented in the modified gait data has been displaced vertically by the calculated displacement amount dz_{L}. In the case where the torso 12 is in the position P_{W2}, the relative position of the left hip joint 31 with respect to the left ankle joint 37 becomes equal to the vector H_{L2} shown in FIG. 6. That is, the distance between the left ankle joint 37 and the left hip joint 31 is equal to the distance between the left ankle joint 37 and the left hip joint 31 represented in the gait data prior to modification, and becomes a distance that can be realized with respect to the left leg link 30. Consequently, by vertically displacing the target position P_{W1} of the torso 12 in the modified gait data with the calculated displacement amount dz_{L}, the modified gait data can be modified to be realizable with respect to the length of the left leg link 30.

When the left torso displacement amount calculating device 152 calculates the displacement amount dz_{L}, a predetermined value that does not exceed the maximum length of the left leg link 30 can be used instead of the distance |H_{L0}| between the left ankle joint 37 and the left hip joint 31 that was calculated from the gait data. The fully extended length of the left leg link 30 refers to the maximum distance that can be realized between both ends of the left leg link 30. That is, it refers to the length of the left leg link 30 when the left knee joint 34 has been extended.

The right leg input position calculating device 146 uses approximately the same process as the left leg input position calculating device 142 to calculate the relative position of the right hip joint 41 with respect to the right ankle joint 47 represented in the gait data prior to modification.

The right leg modified position calculating device 148 uses approximately the same process as the left leg modified position calculating device 144 to calculate the relative position of the right hip joint 41 with respect to the right ankle joint 47 represented in the gait data after modification.

The right torso displacement amount calculating device 154 uses approximately the same process as the left torso displacement amount calculating device 152 to calculate a displacement amount dz_{R} of the right leg link 40.

The displacement amount selecting device 156 determines a torso displacement amount dz for vertically displacing the target position P_{W1} of the torso 12 based on the displacement amount dz_{L} calculated by the left torso displacement amount calculating device 152 and on the displacement amount dz_{R} calculated by the right torso displacement amount calculating device 154. Here, the displacement amount selecting device 156 selects the smaller displacement amount (more precisely, selects the displacement amount that is negative and has a large absolute value) from the displacement amount dz_{L} for the left leg link 30 and the displacement amount dz_{R} for the right leg link 40 to be the torso displacement amount dz. That is, a displacement amount is selected for displacing the target position P_{W1} of the torso 12 vertically downward by the larger amount. If the target position P_{W1} of the torso 12 is displaced vertically downward by the larger amount, the modified gait data is modified to be realizable with respect to the length of the left leg link 30 and the right leg link 40. Further, in the case where the displacement amounts for both legs are positive values, or a vertically downward displacement amount is not calculated, the torso modification amount dz is determined to be zero. That is, the target position P_{W2} of the torso 12 is prohibited from being modified vertically upwards. When the position of the torso 12 displaces vertically upwards, the robot 6 will probably walks unnaturally. By prohibiting the target position P_{W1} of the torso 12 from being displaced vertically upwards, it is possible to prevent the robot 6 from acting unnaturally. The displacement amount dz determined by the displacement amount selecting device 156 is input to the adder 162.

The torso height reading device 158 reads the z coordinate of the target position P_{W1} of the torso 12 described in the gait data modified by the gait data modifying device 112, and inputs the z coordinate to the adder 162. The adder 162 outputs a value obtained by adding the torso displacement amount dz input from the displacement amount selecting device 156 with the z coordinate input from the torso height reading device 158. The torso height renewing device 164 renews the z coordinate of the target position P_{W1} of the torso 12 described in the modified gait data into the value input from the adder 162. The target position of the torso 12 in which the z coordinate has been renewed is input to the joint angle calculating device 118.

As shown in FIG. 2, the gait data modifying device 112 modifies the prepared gait data that is stored in the gait data storage device 110 on the basis of the actual walking state identified by the sensors 124 and the actual motion calculating device 116.

As shown in FIG. 3, the left leg modified position calculating device 144 specifies the position of the left hip joint 31 (the left base end) on the basis of the target position of the torso of the modified gait data. The left leg modified position calculating device 144 also specifies the position of the left ankle joint 37 on the basis of the target position of the left sole 38 described in the modified gait data. The left torso displacement amount calculating device 152 can calculate a vertical displacement amount such that, when the specified position of the left base end is displaced vertically by the vertical displacement amount, a distance between the displaced position of the left base end and the specified position of the ankle joint 37 becomes a predetermined distance. The predetermined distance may be the distance between the left hip joint 31 and the left ankle joint 37 that is calculated from the prepared gait data stored in the gait data storage device 110, or may be the distance between the left hip joint 31 and the left ankle joint 37 when the left knee joint 34 is fully extended.

The right leg modified position calculating device 148 and the right torso displacement amount calculating device 154 calculate the vertical displacement amount of the right leg link 40 in the same manner as described above.

The displacement amount selecting device 156 selects the maximum amount of vertically downward displacement from the vertically displacement amount that has been calculated for each of the leg links. The adder 162 modifies, with the vertical displacement amount selected by the displacement amount selecting device 156, the vertical coordinate of the target position of the torso modified by the gait data modifying device 112.

Instead of the above, the vertical displacement amount may be calculated for only the leg link contacting the ground. In fact, the vertical displacement amount for the leg contacting the ground is often greater vertically downward than the amount for the raised leg link. Consequently, calculating the vertical displacement amount for the leg contacting the ground is often mathematically equal to calculating the maximum amount of vertically downward displacement.

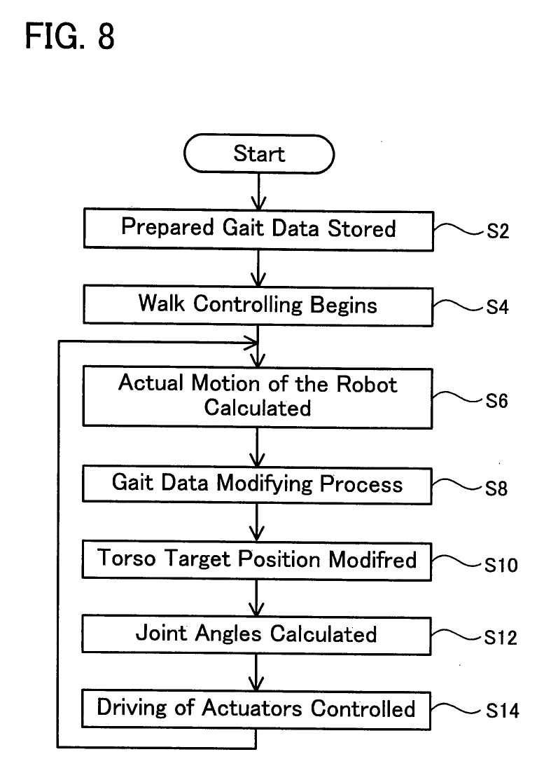

The flow of a walk controlling method will be described with reference to FIG. 8. In step S2, prepared gait data is stored in the gait data storage device 110. In step S4, walk controlling of the robot 6 begins. The robot 6 repeats the processes of step S6 to step S14 described below at a predetermined cycle. In step S6, the actual motion calculating device 116 calculates, on the basis of the output from the sensors 124 mounted on the robot 6, the actual motion performed by the robot 6. In step S8, the gait data modifying device 112 modifies the gait data input in step S2 on the basis of the actual motion of the robot 6 calculated in step S6. In the case where the target position of the torso 12 is to be modified, the gait data modifying device 112 modifies the target position of the torso 12 described in the input gait data so as to be displaced within a horizontal plane. In step S10, the torso position modification device 114 modifies the target position (actually the height) of the torso 12 described in the gait data that has been modified by the gait data modifying device 112. The process performed in step S10 will be described in detail later. In step S12, the gait data modified in step S8 (except the height coordinate of the torso 12) and the torso target height coordinate modified in step S10 are input to the joint angle calculating device 118, and the joint angle calculating device 118 calculates the joint angles θ1 (t), θ2 (t), θ3 (t), . . . of the robot 6 by solving inverse kinematics. In step S14, the joint angles calculated in step S12 are input to the actuator controlling device 120, and the actuator controlling device 120 controls the actuators that move the joints of the robot 6. The robot 6 implements the walking operation. From the sensors 124 mounted on the robot 6, output signals corresponding to the actual state of motion of the robot 6 is input to the actual motion calculating device 116. When the process of step S14 ends, the process returns to step S4.

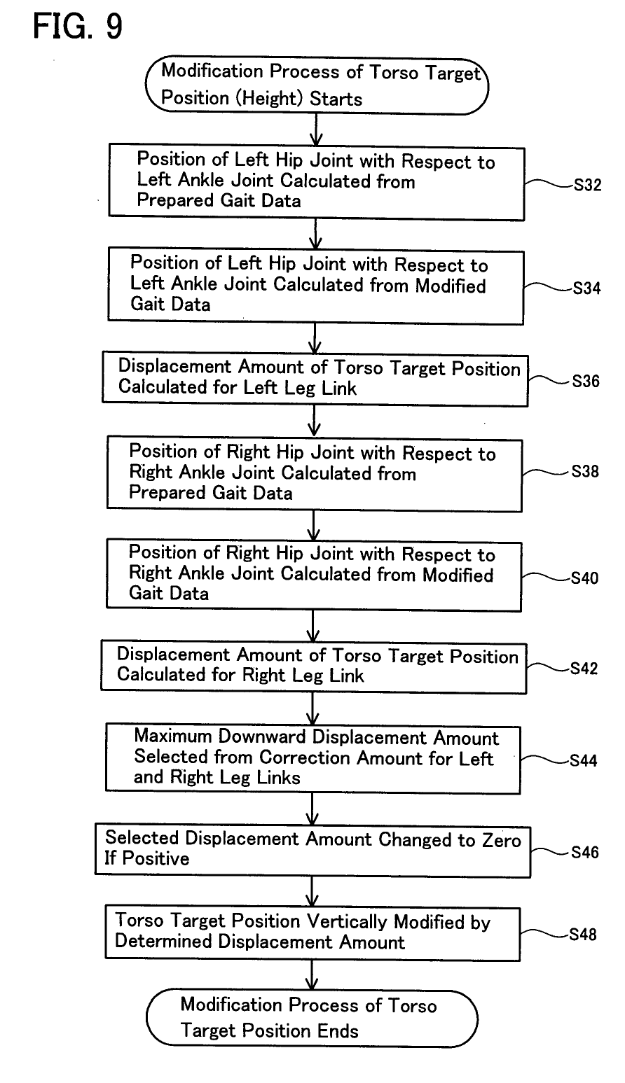

The process performed in step S10 of FIG. 8 will be described in detail with reference to FIG. 9. In step S32, the left leg input position calculating device 142 calculates the positional relationship between the left ankle joint 37 and the left hip joint 31 represented in the gait data that has been stored in step S2. Specifically, the relative position of the left hip joint 31 with respect to the left ankle joint 37 (the vector H_{L0} shown in FIG. 4) is calculated. In step S34, the left leg modified position calculating device 144 calculates the positional relationship between the left ankle joint 37 and the left hip joint 31 represented in the gait data that has been modified in step S8. Specifically, the relative position of the left hip joint 31 with respect to the left ankle joint 37 (the vector H_{L1} shown in FIG. 5) is calculated.

In step S36, the left torso displacement amount calculating device 152 calculates the displacement amount dz_{L} such that, when the z coordinate of the vector H_{L1} calculated in step S34 is modified by the displacement amount dz_{L}, the length of the modified vector (the vector H_{L2} shown in FIG. 6) becomes equal to the length of the vector H_{L0} calculated in step S32. As shown in FIG. 7, when the target position P_{W1} of the torso 12 in the gait data modified by the gait data modifying device 112 is displaced vertically by the displacement amount dz_{L}, the distance between the left ankle joint 37 and the left hip joint 31 represented in the modified gait data becomes equal to the distance between the left ankle joint 37 and the left hip joint 31 represented in the prepared gait data. That is, the distance between the two ends of the left leg link 30 represented in the modified gait data becomes equal to the distance between the two ends of the left leg link 30 represented in the prepared gait data.

In step S38, the right leg input position calculating device 146 calculates the positional relationship between the right ankle joint 47 and the right hip joint 41 represented in the gait data that has been stored in step S2. Specifically, the relational position of the right hip joint 41 with respect to the right ankle joint 47 is calculated. In step S40, the right leg modified position calculating device 148 calculates the positional relationship between the right ankle joint 47 and the right hip joint 41 represented in the gait data modified in step S8. Specifically, the relational position of the right hip joint 41 with respect to the right ankle joint 47 is calculated. In step S42, the right torso displacement amount calculating device 154 calculates the displacement amount dz_{R} such that, when the z coordinate of the vector calculated in step S40 is modified by the displacement amount dz_{R}, the length of the modified vector becomes equal to the length of the vector calculated in step S38. The steps S38-S42 described above are performed for the right leg link 40 in the same manner as the processes performed for the left leg link 30 in the steps S32-S36.

In step S44, the displacement amount selecting device 156 selects the maximum vertically downward amount from the displacement amount dz_{L} for the left leg link 30 calculated in step S36 and the displacement amount dz_{R} for the right leg link 40 calculated in step S42. That is, the displacement amount that causes the greatest vertically downward displacement is selected. In step S46, if the displacement amount selected in step S44 is a positive value, the selected displacement amount is changed to zero. That is, the displacement amount is changed to zero if the selected displacement amount causes vertically upward displacement. That is, if the displacement amount for both the left and the right leg links is positive, or if a vertically downward displacement amount is not calculated, zero is selected.

In step S48, the height coordinate of the target position of the torso 12 that is described in the gait data modified in step S8 is modified vertically downward by the displacement amount determined in steps S44 and S46.

As described above, in the robot 6, the prepared gait data is modified in response to the actual conditions, and the modified gait data is remodified with the length of the left and right leg links 30 and 40 taken into consideration. It is thus possible to allow the gait data to be modified to gait data that cannot be realized due to the limit of the length of the left and right leg links 30 and 40 at the stage of modifying the prepared gait data in response to the actual conditions. It is not necessary to provide extra extension and contraction of the left and right leg links 30 and 40 in the step of generating the prepared gait data. The robot 6 can walks while the knee joint of the leg contacting the ground is extended naturally.

In the robot 6, the target position of the torso 12 is modified to be displaced vertically downward when the modified gait data is modified with the length of the left and right leg links 30 and 40 taken into consideration. In the robot 6, even if the position of the torso moves in the vertical direction, and particularly if the position of the torso moves vertically downward, the ZMP will not deviate significantly, and consequently the robot 6 will not lose its balance due to the modification process.

### Embodiment 2

An embodiment 2 embodied by the present invention will be described with reference to figures. In the present embodiment, the technique of the present invention is applied to a device for generating gait data. The gait data generating device of the present embodiment can be utilized, for example, for generating in advance gait data to be input to the robot 6 of embodiment 1. Below, the gait data generating device of the present embodiment is described in detail by referring to, as an example, the case of generating in advance the gait data to be input to the robot 6.

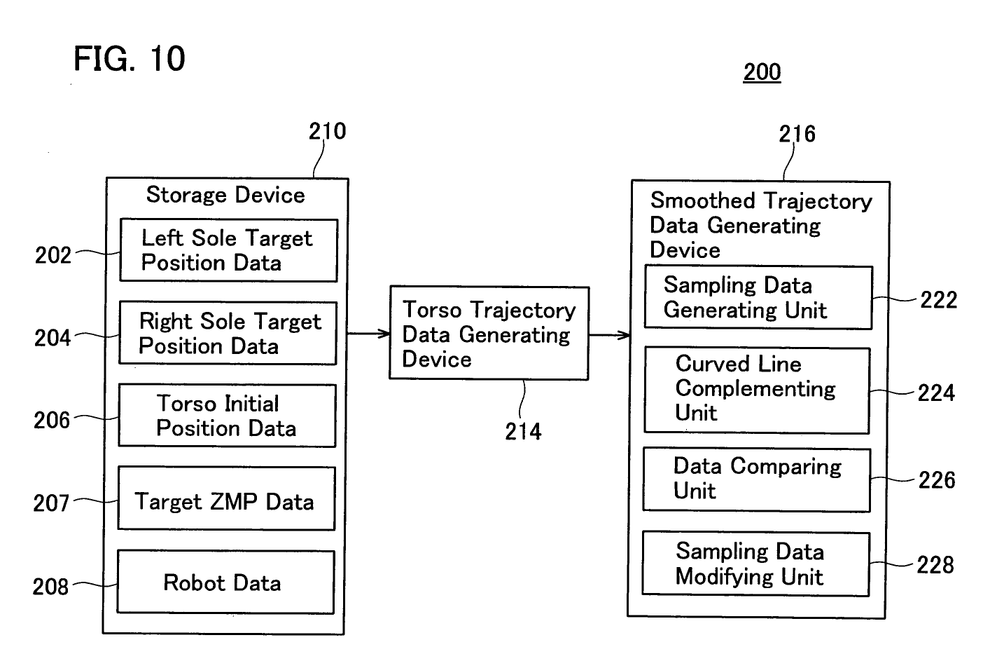

As shown in FIG. 10, a gait data generating device 200 of the present embodiment functionally comprises a storage device 210, a torso trajectory data generating device 214, and a smoothed trajectory data generating device 216.

The storage device 210 stores data input by an operator or the like. The storage device 210 can store left sole target position data 202, right sole target position data 204, torso initial position data 206, target ZMP data 207, robot data 208 in which specification of the robot 6 is stored, etc. The target position data 202 and 204, the torso initial position data 206, and the target ZMP data 207 is data that describes temporal change in position. This data is generated in advance by the operator or the like.

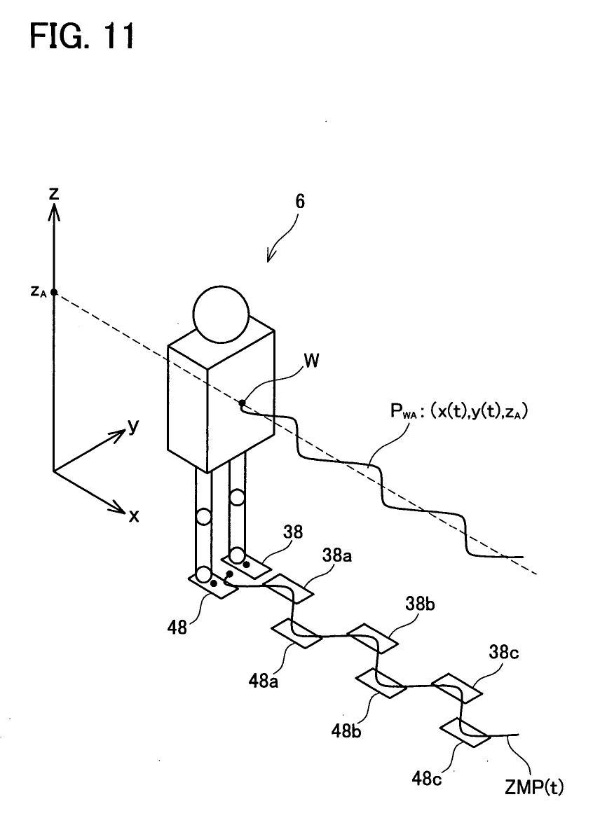

The data stored in the storage device 210 will be described with reference to FIG. 11. The left sole target position data 202 stores temporal changes in a target position (trajectory) of the left sole 38 in case the left sole 38 moves and sequentially makes contact with the ground at the positions 38a, 38b, 38c . . . . The right sole target position data 204 stores temporal changes in a target position (trajectory) of the right sole 48 in case the right sole 48 moves and sequentially makes contact with the ground at the positions 48a, 48b, 48c . . . . The torso initial position data 206 stores temporal change in a target position of the representative point W of the torso 12. The torso initial position data 206 describes a trajectory P_{WA} (t) shown in FIG. 11. The height of the trajectory P_{WA} (t) in the z directions is fixed to be the height z_{A}. The height z_{A} is equal to a height of the representative point W of the torso 12 when the robot 6 is standing upright. That is, the trajectory P_{WA} (t) is on a horizontal plane of which the z coordinate is z_{A}. The gait data generating device 200 of the present embodiment executes the processes described below using the torso target position described in the torso initial position data 206 as an initial value. The target ZMP data 207 describes a trajectory ZMP (t) shown in FIG. 11.

The target position of the torso 12 described in the torso initial position data 206 may be a position that are unrealizable by the robot 6 with respect to the limited length of the left and right leg links 30 and 40. However, at this stage, the gait data generating device 200 allows the target position of the torso 12 described in the torso initial position data 206 to be a position unrealizable by the robot 6.

Here, an example will be given of the method of generating the torso initial position data 206 (the trajectory P_{WA} (t)). First, the trajectory ZMP (t) of the target ZMP is calculated based on the ground contacting positions 38a, 38b, 38c . . . of the left sole 38 described in the left sole target position data 202 and on the ground contacting positions 48a, 48b, 48c . . . of the right sole 48 described in the right sole target position data 204. Next, the height z_{A} of the representative point W of the torso 12 when the robot 6 is standing upright is calculated using the robot data 208. Next, the trajectory P_{WA} (t): (x (t), y (t), z_{A}) is analytically calculated such that the height (the z coordinate) of the representative point W of the torso 12 is fixed and the trajectory ZMP (t) of the target ZMP is fulfilled. The data that describes the trajectory P_{WA} (t) within the horizontal plane is the torso initial position data 206. The torso initial position data 206 can be generated using a conventional gait data generating device.

The torso initial position data 206 need not necessarily describe a target position of the torso that accurately fulfill the target ZMP, but can instead describe a target position that approximately fulfill the target ZMP. Further, instead of the height z_{A} of the representative point W when the robot 6 is standing upright, the height of the trajectory described in the torso initial position data 206 can be fixed on a different height. Furthermore, the height of the trajectory needs not necessarily to be fixed within a horizontal plane. The torso trajectory data generating device 214 generates torso trajectory data based on the data stored in the storage device 210, wherein the torso trajectory data describes the target positions of the torso 12 modified from the torso initial position data 206. The smoothed trajectory data generating device 216 generates smoothed trajectory data by means of modifying the vertical target trajectory of the torso 12 described in the torso trajectory data generated by the torso trajectory data generating device 214 into a smoothed trajectory that forms differentiable continuous curved line. The smoothed trajectory data generating device 216 comprises a sampling data generating unit 222, a curved line complementing unit 224, a data comparing unit 226, a sampling data modifying unit 228, etc.

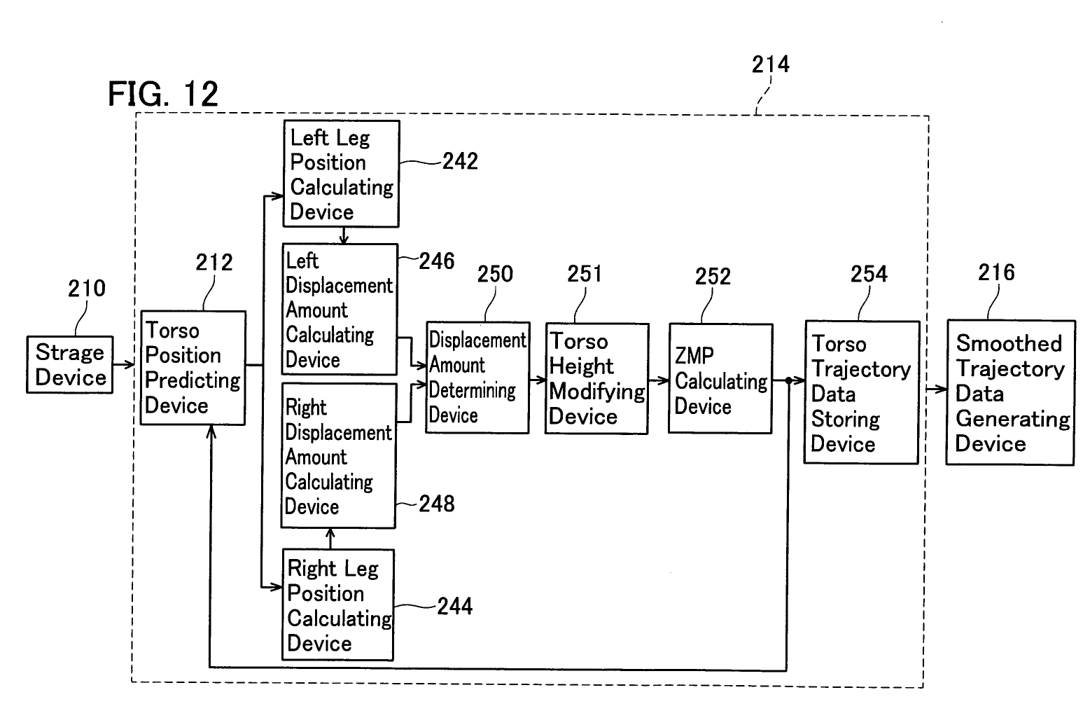

As shown in FIG. 12, the torso trajectory data generating device 214 is provided with a torso position predicting device 212, a left leg position calculating device 242, a right leg position calculating device 244, a left displacement amount calculating device 246, a right displacement amount calculating device 248, a displacement amount determining device 250, a torso height modifying device 251, a ZMP calculating device 252, and a torso trajectory data storing device 254.

The torso position predicting device 212 can predict the target position of the torso 12. The torso position predicting device 212 uses the target position of the torso 12 described in the torso initial position data 206 as the initial value in order to predict the target position of the torso 12. The left leg position calculating device 242 inputs the left sole target position data 202 and the robot data 208 from the storage device 210, and inputs the predicted target position of the torso 12 from the torso position predicting device 212. The left leg position calculating device 242 first utilizes the robot data 208 to grasp the relative positions of the representative point W of the torso 12 and the left hip joint 31. Then, from the relative positions of the representative point W and the left hip joint 31 and from the target position of the torso 12 predicted by the torso position predicting device 212, the left leg position calculating device 242 calculates the position of the left hip joint 31 in case the torso 12 is in the predicted target position. Furthermore, the left leg position calculating device 242 utilizes the robot data 208 to grasp the relative positions of the representative point L of the left sole 38 and the left ankle joint 37. Then, from the relative positions of the representative point L and the left ankle joint 37 and from the target position of the left sole 38 described in the left sole target position data 202, the left leg position calculating device 242 calculates the position of the left ankle joint 37 in case the left sole 38 moves in accordance with the left sole target position data 202. From the position of the left hip joint 31 and the position of the left ankle joint 37 that have been calculated, the left leg position calculating device 242 calculates the relative position of the left ankle joint 37 with respect to the left hip joint 31. That is, the left leg position calculating device 242 calculates a vector that corresponds to the vector H_{L1} shown in FIG. 5 (hereafter, this may be termed the vector corresponding to H_{L1}). Since the vector corresponding to H_{L1} changes over time, it is a function of time (walking time).

The left displacement amount calculating device 246 inputs the robot data 208 from the storage device 210, and inputs the relative position of the left ankle joint 37 with respect to the left hip joint 31 (the vector corresponding to H_{L1}) from the left leg position calculating device 242.

The left displacement amount calculating device 246 first utilizes the robot data 208 to calculate the fully extended length of the left leg link 30. Here, it can make it easy to understand the undermentioned explanation that the fully extended length of the left leg link 30 is regarded as being equal to the length of the vector H_{L0} shown in FIG. 6. Then, the left displacement amount calculating device 246 calculates a displacement amount such that, when the z element of the vector corresponding to H_{L1} calculated by the left leg position calculating device 242 is modified by the displacement amount, the length of the modified vector (that corresponds to the vector H_{L2} shown in FIG. 6) becomes equal to the calculated fully extended length of the left leg link 30. That is, the displacement amount corresponds to the displacement amount dz_{L} in FIG. 6. Since this displacement amount changes over time, it is a function of time (walking time).

By performing approximately the same processes as the left leg position calculating device 242 for the right leg link 40, the right leg position calculating device 244 calculates the relative position of the right hip joint 41 with respect to the right ankle joint 47 when the robot 6 walks according to the predicted target position of the torso 12 and the right sole target position data 204.

By performing approximately the same processes as the left displacement amount calculating device 246, the right displacement amount calculating device 248 calculates the displacement amount for the right leg link 40.

The displacement amount determining device 250 determines the torso displacement amount dz for modifying the predicted target position of the torso 12 in the height direction (the vertical direction) based on the displacement amount calculated by the left displacement amount calculating device 246 and on the displacement amount calculated by the right displacement amount calculating device 248. That is, the displacement amount determining device 250 performs a process equivalent to the process of the displacement amount selecting device 156 provided on the robot 6 of embodiment 1.

The displacement amount determining device 250 inputs the displacement amounts calculated by the left displacement amount calculating device 246 and the right displacement amount calculating device 248, and selects the smaller of these displacement amount (this being positive vertically upward) as the torso displacement amount dz. That is, the displacement amount that is larger in the vertically downward direction is selected.

The torso height modifying device 251 modifies the height (the z coordinate) of the target position of the torso 12 predicted by the torso position predicting device 212 by the displacement amount determined by the displacement amount determining device 250.

The ZMP calculating device 252 calculates the ZMP of the robot 6 on the basis of the data stored in the storage device 210 and on the basis of the target position of the torso 12 modified by the torso height modifying device 251. Then the ZMP that has been calculated is compared with the target ZMP stored in the target ZMP data 207, and the deviation between the two is calculated. If the calculated deviation is equal to or below a predetermined value, the target position of the torso 12 input from the torso height modifying device 251 is input to the torso trajectory data storing device 254. The torso trajectory data storing device 254 stores the target position of the torso 12 that has been input. Alternatively, when the calculated deviation is above the predetermined value, the target position of the torso 12 input from the torso height modifying device 251 is input to the torso position predicting device 212 together with the calculated deviance.

The torso position predicting device 212 inputs the target position of the torso 12 and the deviation of the ZMP from the ZMP calculating device 252, and repredicts the target position of the torso 12. The target position of the torso 12 repredicted by the torso position predicting device 212 is a position which has been displaced in a horizontal direction from the input target position of the torso 12 based on the deviation of the ZMP.

The target position of the torso 12 that has been repredicted by the torso position predicting device 212 is again input to the left leg position calculating device 242 and the right leg position calculating device 244. The z coordinate of the target position of the torso 12 that has been repredicted is remodified, and it is determined whether that fulfills the target ZMP. By repeating the above process, target position of the torso 12 is stored in the torso trajectory data storing device 254, wherein the target position of the torso 12 fulfills the target ZMP and is realizable with respect to the length of the left and right leg links 30 and 40.

The torso trajectory data generating device 214 repeats the aforementioned processes for all of the torso target positions described with time in the torso initial position data 206. As a result, torso trajectory data stores in the torso trajectory data storing device 254, wherein the torso trajectory data describes a torso trajectory data P_{WB} (t) that fulfills the target ZMP and is realizable with respect to the length of the left and right leg links 30 and 40.

The torso trajectory data generated by the torso trajectory data generating device 214 can be utilized as gait data input to the robot 6 together with the left sole target position data 202 and the right sole target position data 204 stored in the storage device 210. When the gait data has been input to the robot 6, the robot 6 walks while naturally extending the left and right leg links 30 and 40. By means of the walk controlling method described in embodiment 1, the robot 6 can continue walking even if unanticipated disturbing force is applied.

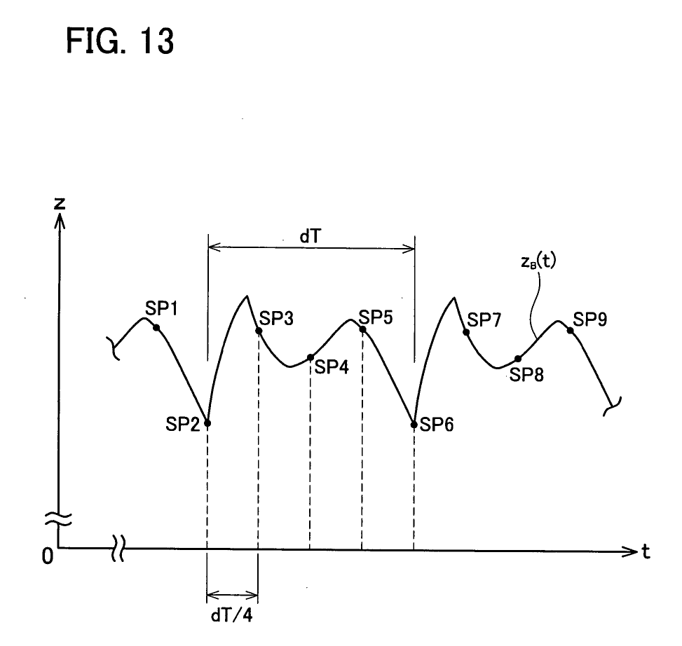

FIG. 13 shows the vertical torso trajectory z_{B} (t) of the torso trajectory data P_{WB} (t). As shown in FIG. 13, the vertical torso trajectory z_{B} (t) of the torso trajectory data P_{WB} (t) changes discontinuously at some points. If this type of torso trajectory data P_{WB} (t) is input to the robot 6, the robot 6 walks with the torso 12 thereof moving violently up and down, and the walking operation of the robot 6 looks unnatural.

To deal with this, the gait data generating device 200 of the present embodiment is provided with the smoothed trajectory data generating device 216.

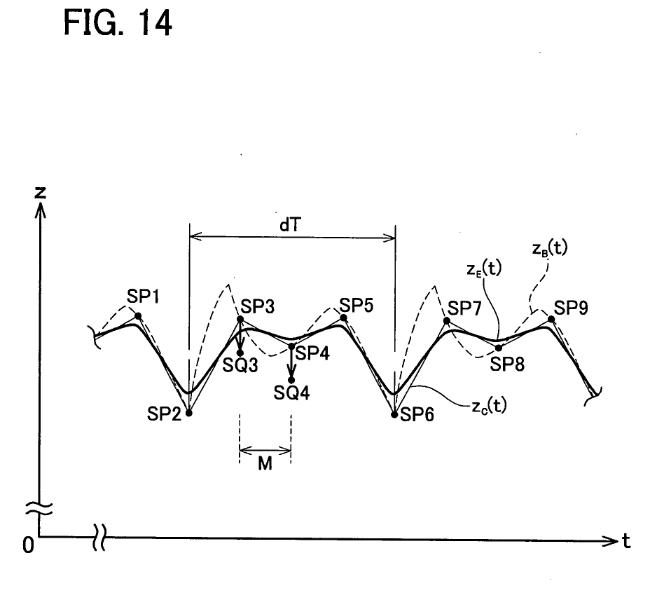

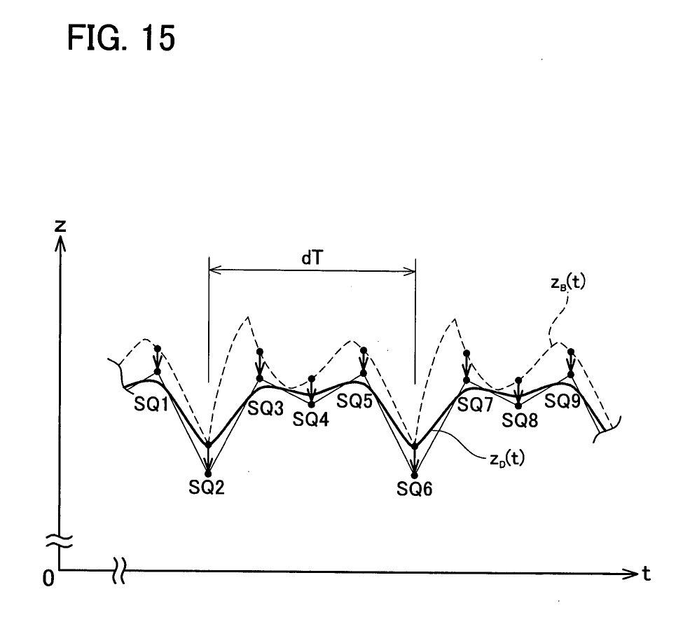

The process of the smoothed trajectory data generating device 216 will be described with reference to FIG. 13, FIG. 14, and FIG. 15. The smoothed trajectory data generating device 216 inputs the torso trajectory data P_{WB} (t) from the torso trajectory data generating device 214.

As shown in FIG. 13, the sampling data generating unit 222 of the smoothed trajectory data generating device 216 performs sampling of trajectory points SP1, SP2, SP3 . . . from the vertical torso trajectory z_{B} (t) described in the input torso trajectory data P_{WB} (t) at intervals of approximately one fourth of one step period dT.

As shown in FIG. 14, the curved line complementing unit 224 of the smoothed trajectory data generating device 216 inputs the sampling data generated by the sampling data generating unit 222, and forms a complemented curved line z_{E} (t) by means of complementing the trajectory points SP1, SP2, SP3 . . . described in the sampling data with a curved line. For details, a complemented refractive line z_{C} (t) is first generated by means of joining the trajectory points SP1, SP2, SP3 . . . with straight lines. Then, the complemented curved line z_{E} (t) is generated by performing a moving average process on the complemented refractive line z_{C} (t). The complemented curved line z_{E} (t) is a trajectory that follows the trajectory points SP1, SP2, SP3 . . . with a differentiable continuous curved line. As shown in FIG. 14, the complemented curved line z_{E} (t) is not limited to passing through the trajectory points SP1, SP2, SP3 . . . . Further, the method of generating the complemented curved line z_{E} (t) is not limited to the aforementioned method. Various other methods of generating an approximate curved line can also be utilized.

The data comparing unit 226 of the smoothed trajectory data generating device 216 compares the vertical trajectory z_{B} (t) described in the torso trajectory data input from the torso trajectory data generating device 214 with the complemented curved line z_{E} (t) generated by the curved line complementing unit 224. Then, when a period is detected in which the complemented curved line z_{E} (t) is vertically upwards from the trajectory z_{B} (t), as shown for example in the period M of FIG. 14, this period is input to the sampling data modifying unit 228.

The sampling data modifying unit 228 extracts, from the sampling data, the trajectory points that demarcate the period input from the data comparing unit 226, and modifies the position of these extracted trajectory points vertically downward by a predetermined amount. For example, in the case of the period M shown in FIG. 14, the trajectory point SP3 is modified to a modified trajectory point SQ3, and the position of the trajectory point SP4 is modified to a modified trajectory point SQ4.

When the sampling data has been modified by the sampling data modifying unit 228, the curved line complementing unit 224 regenerates a complemented curved line. The complemented curved line that has been regenerated by the curved line complementing unit 224 is recompared with the trajectory z_{B} (t) by the data comparing unit 226. If the complemented curved line that has been regenerated is repositioned upwards from the trajectory z_{B} (t), the sampling data modifying unit 228 again modifies the sampling data.

By repeating the above processes, the smoothed trajectory data generating device 216 generates a smoothed vertical trajectory z_{D} (t) shown in FIG. 15. SQ1-SQ9 shown in FIG. 15 are modified trajectory points modified by the sampling data modifying unit 228. The smoothed vertical trajectory z_{D} (t) is vertically downward from the vertical trajectory z_{B} (t) described in the torso trajectory data P_{WB} (t) at all time.

The smoothed trajectory data generating device 216 generates the smoothed trajectory data by renewing the vertical trajectory z_{B} (t) described in the torso trajectory data P_{WB} (t) into the smoothed vertical trajectory z_{D} (t) that has been generated.

As shown in FIG. 15, the smoothed vertical trajectory z_{D} (t) described by the smoothed trajectory data describes a differentiable curved line. When the smoothed trajectory data is input to the robot 6, the robot 6 walks with the torso 12 moving smoothly up and down, and the robot 6 walks with the left and right leg links 30 and 40 extending in a natural manner.

With the smoothed trajectory data, the target position of the torso 12 is moved in the vertical direction with respect to the torso trajectory data P_{WB} (t) generated by the torso trajectory data generating device 214. The position of the ZMP calculated from the torso trajectory data consequently deviates from the position of the target ZMP. Since movement of the torso 12 in the vertical direction has little effect on changing the position of the ZMP, this deviation does not become particularly large, and the robot 6 can walk utilizing the smoothed trajectory data.

Alternatively, the smoothed trajectory data generated by the smoothed trajectory data generating device 216 may be input to the torso trajectory data generating device 214. The torso trajectory data generating device 214 generates new torso trajectory data using the target position of the torso 12 described in the torso trajectory data as the initial value. The torso trajectory data that has been newly generated is input again into the smoothed trajectory data generating device 216, and new smoothed trajectory data is generated. Gait data can thus be generated in which the robot 6 walks with the torso 12 moving smoothly and with the left and right leg links 30 and 40 extend in a natural manner, and in which dynamic balance is accurately maintained.

Specific examples of embodiments of the present invention were described above, but these examples merely illustrate some possibilities of the invention and do not restrict the claims thereof. The art set forth in the claims includes various transformations and modifications of the specific examples explained above.

Furthermore, the technical elements disclosed in the present specification or figures may be utilized independently or in various combinations, and are not limited to the combinations set forth in the claims at the time of filing of the application. Further, the purpose of the example illustrated by the present specification and drawings is to satisfy multiple objectives simultaneously, and satisfying any one of those objectives gives technical value and utility to the present invention.

1. A legged robot comprising:
a torso;
a plurality of leg links wherein a base end of each leg link is swingably connected to the torso and a tip end thereof is provided with a sole;
a gait data modifying means that modifies prepared gait data on the basis of an actual walking state;
an identifying means that identifies a position of the base end for each of the leg links on the basis of a target position of the torso described in the modified gait data;
a displacement amount calculating means that calculates, for each of the leg links, a vertical displacement amount such that, when the identified position of the base end is vertically displaced by the vertical displacement amount, a distance between the displaced position of the base end and a target position of the sole described in the modified gait data becomes equal to a predetermined distance;
a selecting means that selects a maximum vertically downward displacement amount from the vertical displacement amounts calculated for the leg links; and
a target position modifying means that modifies the target position of the torso described in the modified gait data in the vertical directions by the vertical displacement amount selected by the selecting means.

2. A legged robot as in claim 1, further comprising:
a distance calculating means that calculates, for each of the leg links, a distance between a position of the base end identified on the basis of the target position of the torso described in the prepared gait data and a target position of the sole described in the prepared gait data,
wherein the displacement amount calculating means sets the distance calculated by the distance calculating means as the predetermined distance.

3. A legged robot as in claim 1,
wherein the selecting means selects zero if there is no vertically downward displacement amount in the vertical displacement amounts calculated for the leg links.

4. A walk controlling method for a legged robot comprising:
preparing gait data in advance, the gait data describing anticipated walking of the robot provided with a plurality of leg links wherein each leg link comprises a base end swingably connected to a torso and a tip end provided with a sole;
modifying the prepared gait data on the basis of an actual walking state;
identifying a position of the base end for each of the leg links on the basis of a target position of the torso described in the modified gait data;
calculating, for each of the leg links, a vertical displacement amount such that, when the identified position of the base end is vertically displaced by the vertical displacement amount, a distance between the displaced position of the base end and a target position of the sole described in modified gait data becomes equal to a predetermined distance;
selecting a maximum vertically downward displacement amount from the vertical displacement amounts calculated for the leg links;
modifying the target position of the torso described in the modified gait data in the vertical directions by the selected vertical displacement amount; and
inputting the gait data to a joint angle calculating device of the legged robot after modification of the target position of the torso.

5. A device for generating gait data comprising:
a storing means that stores sole target position data describing temporal changes in a target position of a sole for each leg link of a robot, the robot provided with the plurality of leg links wherein a base end of each leg link is swingably connected to a torso and a tip end thereof is provided with the sole;
a predicting means that predicts temporal changes in a target position of the torso that enables the robot to walk in accordance with the sole target position data;
an identifying means that identifies a position of the base end for each of the leg links on the basis of the predicted target position of the torso;
a displacement amount calculating means that calculates, for each of the leg links, a vertical displacement amount such that, when the identified base end position is vertically displaced by the vertical displacement amount, a distance between the displaced position of the base end and the target position of the sole described in the sole target position data becomes equal to a predetermined distance;
a selecting means that selects a maximum vertically downward displacement amount from the vertical displacement amounts calculated for the leg links;
a target position modifying means that modifies the predicted target position of the torso in the vertical directions by the vertical displacement amount selected by the selecting means; and
a repredicting means that repredicts temporal changes in the target position of the torso if the modified target position of the torso is not a position that enables the robot to walk in accordance with the stored sole target position data.

6. A device for generating gait data as in claim 5,
wherein the vertical displacement amount calculating means sets a fully extended length of the leg link as the predetermined distance.

7. A device for generating gait data as in claim 5, further comprising:
a sampling means that samples the modified target positions of the torso at predetermined periods;
a smoothed trajectory generating means that generates a smoothed trajectory, the smoothed trajectory being a continuous curved line that follows the sampled target positions of the torso;
a detecting means that detects a period wherein the generated smoothed trajectory is positioned vertically upward from the modified target position of the torso;
a target position remodifying means that remodifies the modified target position of the torso corresponding to the detected period in the vertically downward direction by a predetermined amount; and
a smoothed trajectory regenerating means that regenerates a smoothed trajectory on the basis of the remodified target position of the torso.

8. A method for generating gait data comprising:
providing and storing sole target position data describing temporal changes in a target position of a sole for each leg link of a robot, the robot provided with the plurality of leg links wherein a base end of each leg link is swingably connected to a torso and a tip end thereof is provided with the sole;
predicting temporal changes in a target position of the torso that enables the robot to walk in accordance with the sole target position data;
identifying a position of the base end for each of the leg links on the basis of the predicted target position of the torso;
calculating, for each of the leg links, a vertical displacement amount such that, when the identified position of the base end is vertically displaced by the vertical displacement amount, a distance between the displaced position of the base end and the target position of the sole described in sole target position data becomes equal to a predetermined distance;
selecting a maximum vertically downward displacement amount from the vertical displacement amounts calculated for the leg links;
modifying the predicted target position of the torso in the vertical direction by the selected vertical displacement amount; and
repredicting temporal changes in the target position of the torso if the modified target position of the torso is not a position that enables the robot to walk in accordance with the stored sole target position data.
